(19) United States
(12) Patent Application Publication
(10) Pub. No.: US 2022/0092358 A1
(43) Pub. Date: Mar. 24, 2022

(54) EVALUATION APPARATUS, EVALUATION METHOD AND PROGRAM

(71) Applicant: Nippon Telegraph and Telephone Corporation, Tokyo (JP)

(72) Inventor: Yoshihide Nakagawa, Musashino-shi, Tokyo (JP)

(21) Appl. No.: 17/423,971

(22) PCT Filed: Jan. 24, 2020
(86) PCT No.: PCT/JP2020/002601

§ 371 Date: Jul. 19, 2021

(30) Foreign Application Priority Data
Jan. 31, 2019 (JP) 2019-016463

(51) Int. Cl. G06K 9/62; G06N 20/00

(52) U.S. Cl. CPC G06K 9/6262; G06N 20/00; G06K 9/6215; G06K 9/6232

(57) ABSTRACT

An evaluation device for evaluating a plurality of dimensionality reduction schemes includes a feature calculation unit configured to extract a first feature of a data set before dimensionality reduction and a second feature of a data set after dimensionality reduction from the data set before dimensionality reduction and the data set after dimensionality reduction for each of the plurality of dimensionality reduction schemes using a plurality of feature extraction algorithms, a feature similarity calculation unit configured to calculate a similarity between the first feature and the second feature using a plurality of feature similarity calculation algorithms corresponding to the plurality of feature extraction algorithms, and an output unit configured to output the similarity calculated for each of the plurality of dimensionality reduction schemes.

### TECHNICAL FIELD

The present invention relates to an evaluation device, an evaluation method, and a program for evaluating a dimensionality reduction scheme.

### BACKGROUND ART

In the field of application of machine learning, for a set of sample data given in advance for learning and answer data, attempts have been made to reduce the number (dimensions) of a feature value of the sample data (for example, properties that characterize the sample data, such as height or weight in a data set regarding a human body) in order to speed up learning and visualize data.

Dimensionality reduction of a feature value is mainly used for machine learning or big data analysis. When a certain sample data set has a very large amount of features, there is a problem in that a very large length of time is required for machine learning and analysis, and humans cannot visually recognize variation of the sample data set. Therefore, it is possible to perform visualization and speeding-up by holding a feature of the data set as far as possible and performing dimensionality reduction on a feature value. There are various dimensionality reduction schemes for feature quantities, and in the related art, an example of a scheme for evaluating an appropriate dimensionality reduction scheme includes a scheme for qualitatively evaluating a data set after dimensionality reduction using a graph or the like. As illustrated in FIG. 1, when a sample data set is dimensionally reduced by dimensionality reduction schemes #1 to #3, a data set after dimensionality reduction is obtained for each of the dimensionality reduction schemes. For simplicity of description, a feature of a data set before dimensionality reduction is shown in a three-dimensional graph and a feature of a data set after dimensionality reduction is shown in a two-dimensional graph below the respective data sets in FIG. 1. The qualitative evaluation using the graphs is a scheme for visually evaluating, from the respective graphs, which of the dimensionality reduction schemes #1 to #3 better captures a feature of an original sample data set.

Further, a technology for evaluating the dimensionality reduction schemes on the basis of a correlation of local distributions for gene analysis has been proposed (NPL 1).

### CITATION LIST

### Non Patent Literature

[NPL 1] Sa muel Kaski, et al., “Trustworthiness and metrics in visualizing similarity of gene expression”, BMC Bioinformatics, 13 Oct. 2003

### SUMMARY OF THE INVENTION

### Technical Problem

There are various dimensionality reduction schemes for a feature value as described above, and it is preferable to evaluate how much information significant in machine learning and analysis is left in the data set after dimensionality reduction. Since the evaluation of the dimensionality reduction scheme of the related art illustrated in FIG. 1 is a qualitative evaluation, the evaluation may become difficult when the number of dimensions increases and an appropriate evaluation is not always performed. Further, the evaluation of the dimensionality reduction scheme in NPL 1 is to evaluate the correlation of the local distribution, and it is difficult for the evaluation to be applied to a case in which the correlation of the local distribution is small. Further, in the related art, there is a problem that the evaluation is limited to one scheme and cannot be performed from a plurality of viewpoints.

An object of the present invention is to provide a technique for evaluating a dimensionality reduction scheme from a plurality of viewpoints.

### Means for Solving the Problem

An evaluation device according to an aspect of the present invention is an evaluation device for evaluating a plurality of dimensionality reduction schemes and includes: a feature calculation unit configured to extract a first feature of a data set before dimensionality reduction and a second feature of a data set after dimensionality reduction from the data set before dimensionality reduction and the data set after dimensionality reduction for each of the plurality of dimensionality reduction schemes using a plurality of feature extraction algorithms; a feature similarity calculation unit configured to calculate a similarity between the first feature and the second feature using a plurality of feature similarity calculation algorithms corresponding to the plurality of feature extraction algorithms; and an output unit configured to output the similarity calculated for each of the plurality of dimensionality reduction schemes.

An evaluation method according to an aspect of the present invention is an evaluation method executed by an evaluation device for evaluating a plurality of dimensionality reduction schemes and includes extracting a first feature of a data set before dimensionality reduction and a second feature of a data set after dimensionality reduction from the data set before dimensionality reduction and the data set after dimensionality reduction for each of the plurality of dimensionality reduction schemes using a plurality of feature extraction algorithms; calculating a similarity between the first feature and the second feature using a plurality of feature similarity calculation algorithms corresponding to the plurality of feature extraction algorithms; and outputting the similarity calculated for each of the plurality of dimensionality reduction schemes.

Further, a program according to one aspect of the present invention causes a computer to function as each of the units of the evaluation device.

### Effects of the Invention

According to the present invention, it is possible to evaluate the dimensionality reduction scheme from a plurality of viewpoints.

### BRIEF DESCRIPTION OF DRAWINGS

FIG. 1 is a diagram illustrating a scheme for evaluating a dimensionality reduction scheme in the related art.

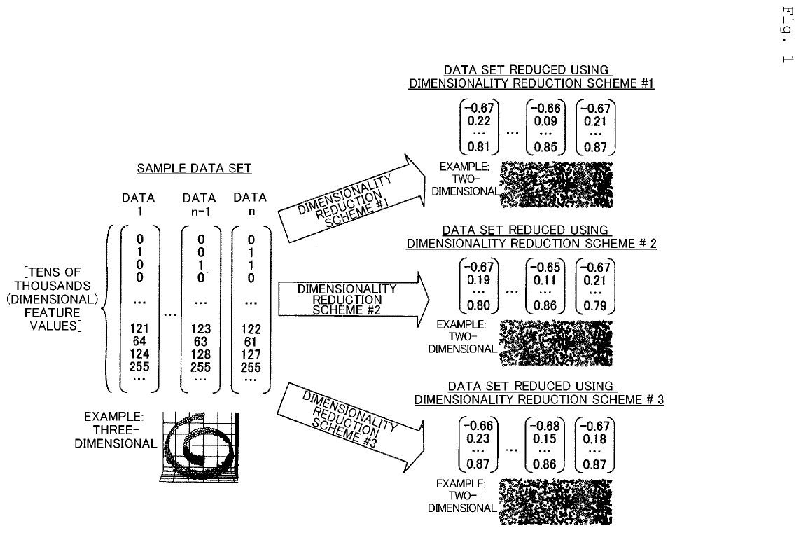

FIG. 2 is a diagram illustrating an example of a network configuration in an embodiment of the present invention.

FIG. 3 is a diagram illustrating a hardware configuration example of a computer constituting an evaluation device in the embodiment of the present invention.

FIG. 4 is a diagram illustrating a functional configuration example of the evaluation device in the embodiment of the present invention.

FIG. 5 is a flowchart illustrating processing of a feature calculation unit and a feature similarity calculation unit.

### DESCRIPTION OF EMBODIMENTS

Hereinafter, embodiments of the present invention will be described with reference to the drawings.

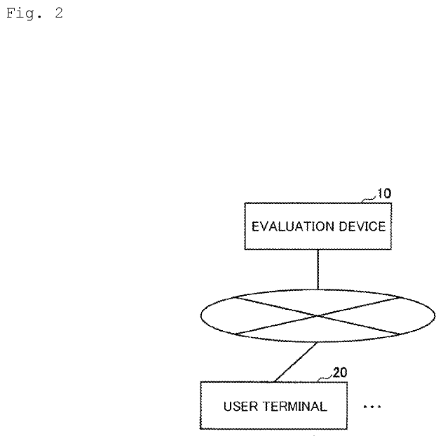

FIG. 2 is a diagram illustrating an example of a network configuration in an embodiment of the present invention. In FIG. 2, an evaluation device 10 is connected to one or more user terminals 20 via a network such as the Internet or a local area network (LAN).

The evaluation device 10 is a device such as a server that can quantitatively evaluate similarity between the features of data sets before and after dimensionality reduction from a plurality of viewpoints without depending on various dimensionality reduction schemes. In order to convert the similarity between the features to a value, the features of the respective data sets are calculated by a feature calculation unit to be described below, a similarity between the features is quantified by a feature similarity calculation unit to be described below, and a list of an optimal dimensionality reduction scheme and the similarity is returned to the user terminal 20.

The user terminal 20 is a terminal that receives an input of data or evaluation conditions to the evaluation device 10 from the user and outputs (displays) an evaluation result of the evaluation device 10. For example, a personal computer (PC), a smartphone, a tablet terminal, or the like may be used as the user terminal 20.

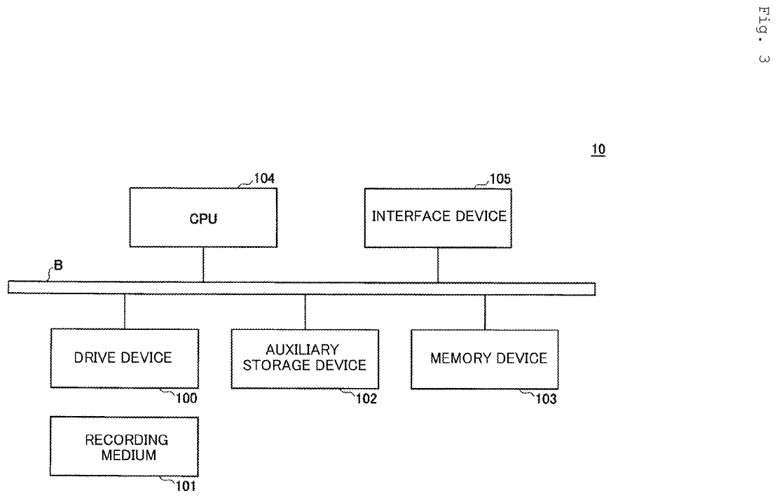

FIG. 3 is a diagram illustrating a hardware configuration example of a computer constituting the evaluation device 10 in the embodiment of the present invention. The computer constituting the evaluation device 10 includes, for example, a drive device 100, an auxiliary storage device 102, a memory device 103, a CPU 104, and an interface device 105 that are connected to each other by a bus B.

A program that realizes processing in the evaluation device 10 is provided by a recording medium 101 such as a CD-ROM. When the recording medium 101 storing the program is set in the drive device 100, the program is installed in the auxiliary storage device 102 from the recording medium 101 via the drive device 100. However, the program does not necessarily have to be installed from the recording medium 101 and may be downloaded from another computer via the network. The auxiliary storage device 102 stores the installed program and also stores, for example, necessary files or data.

The memory device 103 reads the program from the auxiliary storage device 102 and stores the program when there is an instruction to start the program. The CPU 104 executes functions relevant to the evaluation device 10 according to the program stored in the memory device 103. The interface device 105 may be used as an interface for connection to a network.

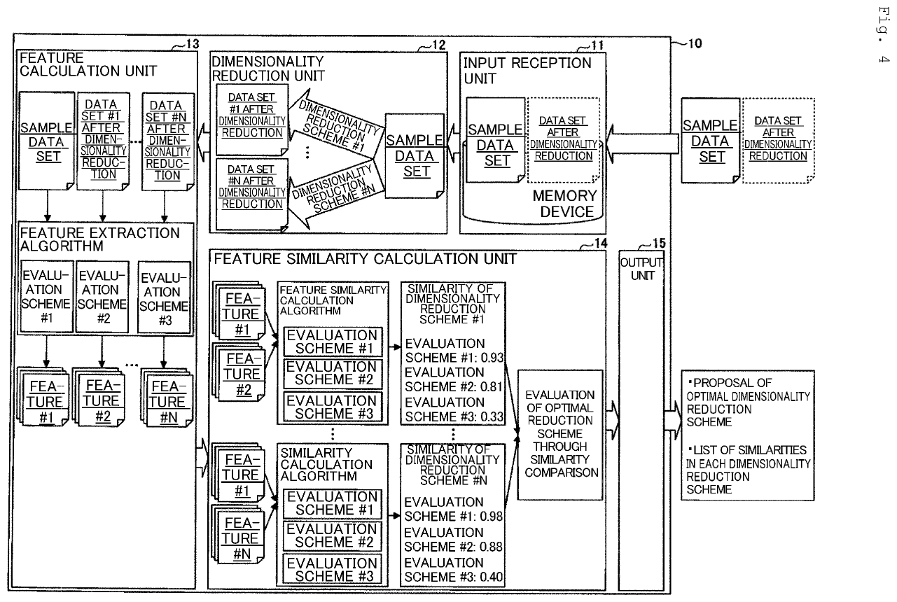

FIG. 4 is a diagram illustrating a functional configuration example of the evaluation device 10 in the embodiment of the present invention. In FIG. 4, the evaluation device 10 includes, for example, an input reception unit 11, a dimensionality reduction unit 12, a feature calculation unit 13, a feature similarity calculation unit 14, and an output unit 15. Each of the units is realized by processing of causing the CPU 104 to execute one or more programs installed in the evaluation device 10.

The input reception unit 11 receives the sample data set (data set before dimensionality reduction), the data set after dimensionality reduction, and the evaluation conditions input in the user terminal 20 from the user terminal 20, and stores the sample data set and the data set after dimensionality reduction in the memory device 103 or the like.

The sample data set that the input reception unit 11 receives from the user terminal 20 is a set of data such as traffic data or sensor data. For example, each piece of traffic data is composed of a plurality of feature values such as an IP, a port, a protocol, the number of packets, and a length. The data set after dimensionality reduction is a data set after the number (dimensions) of feature values of the sample data set has been reduced. When the dimensionality reduction unit 12 to be described below performs dimensionality reduction, the input reception unit 11 does not have to receive the data set after dimensionality reduction.

The evaluation conditions include which of a plurality of evaluation schemes to be described below is used to evaluate the dimensionality reduction scheme (a plurality of evaluation schemes can be selected), and when the dimensionality reduction unit 12 performs dimensionality reduction, the evaluation conditions include a dimensionality reduction scheme (multiple selections allowed) for an evaluation target.

When the input reception unit 11 does not receive the data set after dimensionality reduction, the dimensionality reduction unit 12 performs dimensionality reduction on the sample data set using the dimensionality reduction scheme for an evaluation target received by the input reception unit 11 to generate a data set after dimensionality reduction.

The feature calculation unit 13 receives the sample data set and the data set after dimensionality reduction from the input reception unit 11 or the dimensionality reduction unit 12, and extracts a feature of the sample data set and a feature of the data set after dimensionality reduction for each dimensionality reduction scheme using a plurality of feature extraction algorithms. The feature calculation unit 13 may convert these features into a matrix or a vector.

The feature similarity calculation unit 14 calculates a similarity between a matrix or vector representing the feature of the sample data set and a matrix or vector representing the feature of the data set after dimensionality reduction using a plurality of feature similarity calculation algorithms respectively corresponding to the plurality of feature extraction algorithms used in the feature calculation unit 13. It can be said that when the similarity is higher, the features of the data sets before and after dimensionality reduction are more similar to each other. The feature similarity calculation unit 14 can determine the optimal dimensionality reduction scheme on the basis of the similarity calculated in each dimensionality reduction scheme.

The output unit 15 proposes the optimal dimensionality reduction scheme and outputs a list of similarities in the respective dimensionality reduction schemes.

Hereinafter, functions of the feature calculation unit 13 and the feature similarity calculation unit 14 will be described in connection with three specific evaluation schemes for evaluating the dimensionality reduction scheme. Which of the three evaluation schemes is to be used depends on the evaluation conditions received by the input reception unit 11.

(1) Evaluation Scheme #1: Scheme for Extracting a Feature of a Global Distribution of Each Point and Calculating a Similarity

The feature extraction algorithm of evaluation scheme #1 is as follows.

For a data set A=[a₁, a₂, . . . , aₙ] before dimensionality reduction and a data set B=[b₁, b₂, . . . , bₙ] after dimensionality reduction, the feature calculation unit 13 forms a relationship between respective points (respective pieces of data) of the respective data sets as a matrix. A relationship between the respective points is a distance and an inner product, which can be selected by the user as necessary. When the relationship between the respective points is expressed by the distance, a distance between the respective points of the data set before dimensionality reduction is expressed by the following matrix

$${R}^{A} = [ \begin{matrix}{r}_{11}^{A} & ⋯ & {r}_{1 n}^{1} \\ ⋮ & ⋱ & ⋮ \\ {r}_{n 1}^{A} & ⋯ & {r}_{nn}^{A}\end{matrix} ] , \\ {r}_{ij}^{A} = {‖ {a}_{i} - {a}_{j} ‖}_{2} \qquad [ Formula 1 ]$$

Further, when the relationship between the respective points is represented by the inner product, an inner product between respective points of each data set before dimensionality reduction is expressed by the following matrix R^{A}.

$${R}^{A} = [ \begin{matrix}{r}_{11}^{A} & ⋯ & {r}_{1 n}^{1} \\ ⋮ & ⋱ & ⋮ \\ {r}_{n 1}^{A} & ⋯ & {r}_{nn}^{A}\end{matrix} ] , \\ {r}_{ij}^{A} = \frac{{a}_{i} \cdot {a}_{j}}{\vert {a}_{i} \vert \vert {a}_{j} \vert} \qquad [ Formula 2 ]$$

A matrix R^{B} of the data after dimensionality reduction can be similarly calculated.

A feature similarity calculation algorithm of evaluation scheme #1 is as follows.

The feature similarity calculation unit 14 calculates a correlation coefficient between the matrix R^{A} and the matrix R^{B}. Specifically, the similarity is calculated using a Pearson's product moment correlation coefficient.

(2) Evaluation Scheme #2: Scheme for Extracting a Feature of a Local Distribution of Each Point and Calculating a Similarity

This evaluation scheme uses a Trustworthiness calculation formula (NPL 1). A feature extraction algorithm of evaluation scheme #2 is as follows.

The feature calculation unit 13 classifies the data before dimensionality reduction and the data after dimensionality reduction using the Trustworthiness calculation formula and sets a classification prediction thereof as a feature. Specifically, for the data set A=[a₁, a₂, . . . , aₙ] before dimensionality reduction, the feature calculation unit 13 calculates a rank of aⱼ when aⱼ are arranged in an order from the side closest to aᵢ. Further, for the data set B=[b₁, b₂, . . . , bₙ] after dimensionality reduction, the feature calculation unit 13 extracts points up to a k-th point from the side closest to each point (each piece of data).

A feature similarity calculation algorithm of evaluation scheme #2 is as follows.

The feature similarity calculation unit 14 calculates the following feature vector R for the data set A=[a₁, a₂, . . . , aₙ] before dimensionality reduction and the data set B=[b₁, b₂, . . . , bₙ] after dimensionality reduction.

$$R = [ {r}_{1} , {r}_{2} , … , {r}_{n} ] , \\ {r}_{i} = {\sum }_{j ∈ {U}_{( {b}_{i} )}^{k}} ( r ( {a}_{j} , {a}_{i} ) - k ) \qquad [ Formula 3 ]$$

### Here,

$${U}_{( {b}_{i} )}^{k} \qquad [ Formula 4 ]$$

is a set of indexes of points from a point closest to bᵢ to a k-th point (a set of points extracted by the feature calculation unit 13), and r(aⱼ, aᵢ) is the rank of aⱼ when aⱼ are arranged in an order from the side closest to aᵢ (a rank calculated by the feature calculation unit 13).

The feature similarity calculation unit 14 calculates the similarity using the following formula.

$$r = 1 - \frac{2}{nk ( 2 n - 3 k - 1 )} {\sum }_{i = 1}^{n} ( {r}_{i} ) \qquad [ Formula 5 ]$$

(3) Scheme #3: Scheme for Calculating Similarity Using Machine Learning Results

A feature extraction algorithm of evaluation scheme #3 is as follows.

It is assumed that a machine learning model that classifies the data set before dimensionality reduction (a data set for training) and the data set after dimensionality reduction (a data set for training) in advance using machine learning, and outputs the vector R^{A} representing the feature of the data set before dimensionality reduction and R^{B} representing the feature of the data set after dimensionality reduction has been constructed. The feature calculation unit 13 extracts the vectors R^{A}=[ r₁^{A}, r₂^{A}, . . . , rₙ^{A}] and R_{B}=[r₁^{B}, r₂^{B}, . . . , rₙ^{B}] obtained by classifying the data set A=[a₁, a₂, . . . , aₙ] before dimensionality reduction and the data set B=[b₁, b₂, . . . , bₙ] after dimensionality reduction using a machine learning model subjected to learning.

A feature similarity calculation algorithm of evaluation scheme #3 is as follows.

The feature similarity calculation unit 14 calculates the similarity using the following formula on the basis of whether or not respective components of the vectors R_{A} and R_{B} match.

$$r = \frac{{\sum }_{i = 1}^{n} f ( {r}_{i}^{A} , {r}_{i}^{B} )}{n} , \\ f ( x , y ) = \{ \begin{matrix}1 & ( x = y ) \\ 0 & ( x \neq y )\end{matrix} \qquad [ Formula 6 ]$$

Using the three schemes, a list of similarities of the evaluation schemes #1 to #3 can be obtained in the dimensionality reduction schemes #1 to #N shown in FIG. 4.

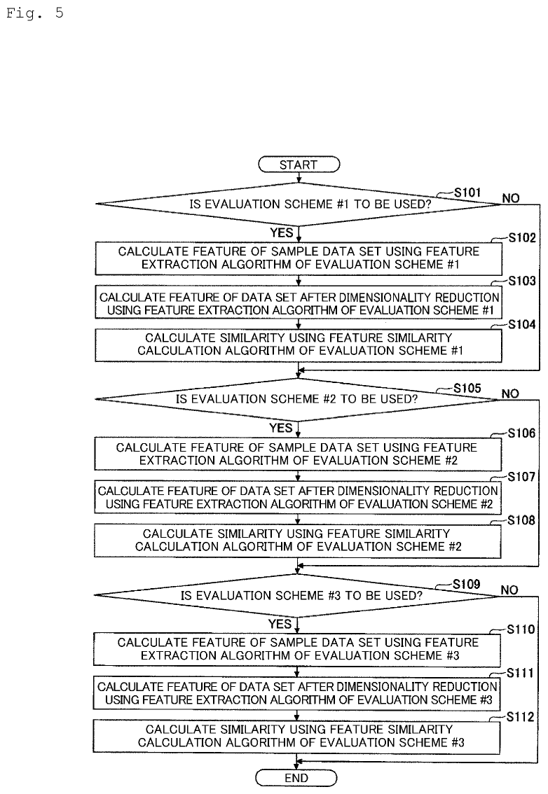

FIG. 5 is a flowchart illustrating processing of the feature calculation unit 13 and the feature similarity calculation unit 14. Here, it is assumed that the evaluation schemes #1 to #3 can be used in the evaluation device 10, and which of the evaluation schemes #1 to #3 is to be used is received by the input reception unit 11.

In step S101, the feature calculation unit 13 determines whether or not the evaluation scheme #1 is to be used. When the evaluation scheme #1 is to be used, the processing proceeds to step S102, and when the evaluation scheme #1 is not to be used, the processing proceeds to step S105.

In step S102, the feature calculation unit 13 calculates the feature R^{A} of the sample data set according to the evaluation scheme #1.

In step S103, the feature calculation unit 13 calculates the feature R^{B} of the data set after dimensionality reduction according to the evaluation scheme #1.

In step S104, the feature similarity calculation unit 14 calculates the similarity according to the evaluation scheme #1.

In step S105, the feature calculation unit 13 determines whether or not the evaluation scheme #2 is to be used. When the evaluation scheme #2 is to be used, the processing proceeds to step S106, and when the evaluation scheme #2 is not to be used, the processing proceeds to step S109.

In step S106, the feature calculation unit 13 extracts r(aⱼ, aᵢ) according to the evaluation scheme #2.

In step S107, the feature calculation unit 13 extracts a set of indexes of points from a point closest to bᵢ to a k-th point according to the evaluation scheme #2.

In step S108, the feature similarity calculation unit 14 calculates the similarity according to the evaluation scheme #2.

In step S109, the feature calculation unit 13 determines whether or not the evaluation scheme #3 is to be used. When the evaluation scheme #3 is to be used, the processing proceeds to step S110, and when the evaluation scheme #3 is not to be used, the processing ends.

In step S110, the feature calculation unit 13 calculates the feature R^{A} of the sample data set according to the evaluation scheme #3.

In step S103, the feature calculation unit 13 calculates the feature R^{B} of the data set after dimensionality reduction according to the evaluation scheme #3.

In step S104, the feature similarity calculation unit 14 calculates the similarity according to the evaluation scheme #3.

Further, the feature similarity calculation unit 14 determines the optimal dimensionality reduction scheme on the basis of the similarity calculated in each dimensionality reduction scheme. For example, the feature similarity calculation unit 14 may compare the obtained similarity with a threshold value and determine that a dimensionality reduction scheme in which all the similarities are higher than the threshold value is the optimal dimensionality reduction scheme and may determine that a dimensionality reduction scheme in which a variation in the similarities is small is the optimal dimensionality reduction scheme as a result of evaluation using a plurality of sample data sets.

According to the present embodiment, when the dimensionality reduction schemes are compared and selected, it becomes possible to quantitatively evaluate the dimensionality reduction scheme from a plurality of viewpoints and propose the optimal dimensionality reduction scheme. Further, the evaluation scheme #1 is a scheme in which a similarity of a distribution of global data can be calculated, the evaluation scheme #2 is a scheme in which the correlation of the local distribution can be calculated, and the evaluation scheme #3 is a scheme in which evaluation results using actual data can be reflected. By combining these evaluation schemes, it becomes possible to evaluate the dimensionality reduction scheme from various viewpoints.

Although the embodiment of the present invention has been described in detail above, the present invention is not limited to such a specific embodiment and various modifications and changes can be made without departing from the scope of the gist of the present invention described in the claims.

### REFERENCE SIGNS LIST

10 Evaluation device
11 Input reception unit
12 Dimensionality reduction unit
13 Feature calculation unit
14 Feature similarity calculation unit
15 Output unit
20 User terminal

1. An evaluation device for evaluating a plurality of dimensionality reduction schemes, the evaluation device comprising:
a feature calculation unit, including one or more processors, configured to extract a first feature of a data set before dimensionality reduction and a second feature of a data set after dimensionality reduction from the data set before dimensionality reduction and the data set after dimensionality reduction for each of the plurality of dimensionality reduction schemes using a plurality of feature extraction algorithms;
a feature similarity calculation unit, including one or more processors, configured to calculate a similarity between the first feature and the second feature using a plurality of feature similarity calculation algorithms corresponding to the plurality of feature extraction algorithms; and
an output unit, including one or more processors, configured to output the similarity calculated for each of the plurality of dimensionality reduction schemes.

2. The evaluation device according to claim 1, wherein a first feature extraction algorithm among the plurality of feature extraction algorithms is an algorithm for extracting a matrix representing a distance or inner product between respective pieces of data in the data set before dimensionality reduction as the first feature, and extracting a matrix representing a distance or inner product between respective pieces of data in the data set after dimensionality reduction as the second feature, and a first feature similarity calculation algorithm corresponding to the first feature extraction algorithm is an algorithm for calculating a correlation coefficient between the first feature and the second feature.

3. The evaluation device according to claim 1, wherein a second feature extraction algorithm among the plurality of feature extraction algorithms is an algorithm for extracting a vector representing the first feature and a vector representing the second feature from the data set before dimensionality reduction and the data set after dimensionality reduction using a machine learning model constructed by machine learning using the data set before dimensionality reduction for training and the data set after dimensionality reduction for training, and a second feature similarity calculation algorithm corresponding to the second feature extraction algorithm is an algorithm for calculating the similarity on the basis of whether or not each component of the vector representing the first feature and each component of the vector representing the second feature match.

4. The evaluation device according to claim 1, wherein the feature similarity calculation unit, including one or more processors, is configured to determine an optimal dimensionality reduction scheme on the basis of the similarity calculated for each of the plurality of dimensionality reduction schemes, and the output unit, including one or more processors, is configured to output the determined optimal dimensionality reduction scheme.

5. The evaluation device according to claim 1, further comprising:
an input reception unit, including one or more processors, configured to receive the data set before dimensionality reduction; and
a dimensionality reduction unit, including one or more processors, configured to generate a data set after dimensionality reduction obtained by reducing a dimension of the data set before dimensionality reduction using the plurality of dimensionality reduction schemes.

6. An evaluation method executed by an evaluation device for evaluating a plurality of dimensionality reduction schemes, the evaluation method comprising:
extracting a first feature of a data set before dimensionality reduction and a second feature of a data set after dimensionality reduction from the data set before dimensionality reduction and the data set after dimensionality reduction for each of the plurality of dimensionality reduction schemes using a plurality of feature extraction algorithms;
calculating a similarity between the first feature and the second feature using a plurality of feature similarity calculation algorithms corresponding to the plurality of feature extraction algorithms; and
outputting the similarity calculated for each of the plurality of dimensionality reduction schemes.

7. The evaluation method of claim 6, wherein a first feature extraction algorithm among the plurality of feature extraction algorithms is an algorithm for extracting a matrix representing a distance or inner product between respective pieces of data in the data set before dimensionality reduction as the first feature, and extracting a matrix representing a distance or inner product between respective pieces of data in the data set after dimensionality reduction as the second feature, and a first feature similarity calculation algorithm corresponding to the first feature extraction algorithm is an algorithm for calculating a correlation coefficient between the first feature and the second feature.

8. The evaluation method of claim 6, wherein a second feature extraction algorithm among the plurality of feature extraction algorithms is an algorithm for extracting a vector representing the first feature and a vector representing the second feature from the data set before dimensionality reduction and the data set after dimensionality reduction using a machine learning model constructed by machine learning using the data set before dimensionality reduction for training and the data set after dimensionality reduction for training, and a second feature similarity calculation algorithm corresponding to the second feature extraction algorithm is an algorithm for calculating the similarity on the basis of whether or not each component of the vector representing the first feature and each component of the vector representing the second feature match.

9. The evaluation method of claim 6, further comprising:
determining an optimal dimensionality reduction scheme on the basis of the similarity calculated for each of the plurality of dimensionality reduction schemes; and
outputting the determined optimal dimensionality reduction scheme.

10. The evaluation method of claim 6, further comprising:
receiving the data set before dimensionality reduction; and
generating a data set after dimensionality reduction obtained by reducing a dimension of the data set before dimensionality reduction using the plurality of dimensionality reduction schemes.

11. A non-transitory computer readable medium storing one or more instructions causing a computer to execute:
evaluating a plurality of dimensionality reduction schemes, wherein evaluating the plurality of dimensionality reduction schemes comprises:
extracting a first feature of a data set before dimensionality reduction and a second feature of a data set after dimensionality reduction from the data set before dimensionality reduction and the data set after dimensionality reduction for each of the plurality of dimensionality reduction schemes using a plurality of feature extraction algorithms;
calculating a similarity between the first feature and the second feature using a plurality of feature similarity calculation algorithms corresponding to the plurality of feature extraction algorithms; and
outputting the similarity calculated for each of the plurality of dimensionality reduction schemes.

12. The non-transitory computer readable medium according to claim 11, wherein a first feature extraction algorithm among the plurality of feature extraction algorithms is an algorithm for extracting a matrix representing a distance or inner product between respective pieces of data in the data set before dimensionality reduction as the first feature, and extracting a matrix representing a distance or inner product between respective pieces of data in the data set after dimensionality reduction as the second feature, and a first feature similarity calculation algorithm corresponding to the first feature extraction algorithm is an algorithm for calculating a correlation coefficient between the first feature and the second feature.

13. The non-transitory computer readable medium according to claim 11, wherein a second feature extraction algorithm among the plurality of feature extraction algorithms is an algorithm for extracting a vector representing the first feature and a vector representing the second feature from the data set before dimensionality reduction and the data set after dimensionality reduction using a machine learning model constructed by machine learning using the data set before dimensionality reduction for training and the data set after dimensionality reduction for training, and a second feature similarity calculation algorithm corresponding to the second feature extraction algorithm is an algorithm for calculating the similarity on the basis of whether or not each component of the vector representing the first feature and each component of the vector representing the second feature match.

14. The non-transitory computer readable medium according to claim 11, further comprising:
determining an optimal dimensionality reduction scheme on the basis of the similarity calculated for each of the plurality of dimensionality reduction schemes; and
outputting the determined optimal dimensionality reduction scheme.

15. The non-transitory computer readable medium according to claim 11, further comprising: receiving the data set before dimensionality reduction; and
generating a data set after dimensionality reduction obtained by reducing a dimension of the data set before dimensionality reduction using the plurality of dimensionality reduction schemes.
